(19) United States
(12) Patent Application Publication
(10) Pub. No.: US 2023/0039163 A1
(43) Pub. Date: Feb. 9, 2023

(54) OPTICAL FIBER, AND METHOD OF MANUFACTURING OPTICAL FIBER

(71) Applicant: SUMITOMO ELECTRIC INDUSTRIES, LTD., Osaka (JP)

(72) Inventors: Takahiro NOMURA, Osaka (JP); Kazuyuki SOHMA, Osaka (JP)

(73) Assignee: SUMITOMO ELECTRIC INDUSTRIES, LTD., Osaka (JP)

(21) Appl. No.: 17/860,974

(22) Filed: Jul. 8, 2022

(30) Foreign Application Priority Data
Jul. 14, 2021 (JP) 2021-116167

(51) Int. Cl. G02B 6/02; C03C 25/1025; C03B 37/025

(52) U.S. Cl. CPC G02B 6/02395; C03C 25/1025; C03B 37/025

(57) ABSTRACT

An optical fiber includes a glass fiber, and a resin coating layer covering an outer circumference of the glass fiber. In a spectrum acquired by measuring an amount of eccentricity of the glass fiber from a central axis based on an outer circumference of the resin coating layer at a plurality of measurement points set at a predetermined interval in an axial direction of the glass fiber and applying Fourier transform of a waveform representing the amount of eccentricity at each of the plurality of measurement points, a largest value of amplitude of the amount of eccentricity is 6 μm or less.

### CROSS REFERENCES TO RELATED APPLICATIONS

The present invention contains subject matter related to Japanese Patent Application No. 2021-116167 filed in the Japan Patent Office on Jul. 14, 2021, the entire contents of which are incorporated herein by reference.

### BACKGROUND OF THE INVENTION

### 1. Field of the Invention

The present disclosure relates to an optical fiber and a method of manufacturing the optical fiber.

### 2. Description of the Related Art

In Japanese Unexamined Patent Application Publication No. 2003-292334, an optical fiber acquired by covering the outer circumference of a glass fiber with a resin coating layer is disclosed.

### SUMMARY OF THE INVENTION

An object of the present disclosure is to suppress an optical fiber break.

According to an aspect of the present disclosure, an optical fiber includes a glass fiber, and a resin coating layer covering an outer circumference of the glass fiber. In a spectrum acquired by measuring an amount of eccentricity of the glass fiber from a central axis based on an outer circumference of the resin coating layer at a plurality of measurement points set at a predetermined interval in an axial direction of the glass fiber and applying Fourier transform of a waveform representing the amount of eccentricity at each of the plurality of measurement points, a largest value of amplitude of the amount of eccentricity is 6 μm or less.

According to another aspect of the present disclosure, an optical fiber includes a glass fiber, and a resin coating layer covering an outer circumference of the glass fiber. In a spectrum acquired by measuring an amount of eccentricity of the glass fiber from a central axis based on an outer circumference of the resin coating layer at a plurality of measurement points set at a predetermined interval in an axial direction of the glass fiber and applying Fourier transform of a waveform representing the amount of eccentricity at each of the plurality of measurement points, a wavelength at which amplitude of the amount of eccentricity is largest is 0.1 m or more.

According to another aspect of the present disclosure, a method of manufacturing an optical fiber includes forming a glass fiber, forming a resin coating layer such that an outer circumference of the glass fiber is covered, curing the resin coating layer by using a predetermined curing device, and pulling the optical fiber the resin coating layer of which is cured. Forming the resin coating layer includes setting an outer circumferential diameter of the resin coating layer to 190 μm or less. Pulling the optical fiber includes setting a circumference length of a largest roller among all rollers to 0.2 m or more, the largest roller consists of a turning roller located just beneath the curing device and a plurality of guide rollers located downstream from the turning roller, to 0.2 m or more.

According to another aspect of the present disclosure, a method of manufacturing an optical fiber includes forming a glass fiber, forming a resin coating layer such that an outer circumference of the glass fiber is covered, curing the resin coating layer by using a predetermined curing device, and pulling the optical fiber the resin coating layer of which is cured. Forming the resin coating layer includes setting an outer circumferential diameter of the resin coating layer to 190 μm or less. Pulling the optical fiber includes damping vibration of the optical fiber by using a vibration damper installed downstream of the curing device and upstream of a turning roller located directly beneath the curing device.

According to another aspect of the present disclosure, a method of manufacturing an optical fiber includes forming a glass fiber, forming a resin coating layer such that an outer circumference of the glass fiber is covered, curing the resin coating layer by using a predetermined curing device, and pulling the optical fiber the resin coating layer of which is cured. Forming the resin coating layer includes setting an outer circumferential diameter of the resin coating layer to 190 μm or less. Pulling the optical fiber includes using a turning roller located just beneath the curing device with the turning roller fixed separately from another device member related to manufacturing of the optical fiber.

### BRIEF DESCRIPTION OF THE DRAWINGS

FIG. 1 schematically illustrates a sectional view of an optical fiber according to an embodiment of the present disclosure.

FIG. 2 schematically illustrates a sectional view for describing the definition of the amount of eccentricity of a glass fiber.

FIG. 3 illustrates an eccentricity waveform that represents the amount of eccentricity of the glass fiber at a position on the glass fiber in the axial direction.

FIG. 4 illustrates an example of a spectrum acquired by the Fourier transform of the eccentricity waveform.

FIG. 5 schematically illustrates the structure of an optical-fiber-manufacturing apparatus according to an embodiment of the present disclosure.

### DESCRIPTION OF THE PREFERRED EMBODIMENTS

### Description of Embodiment of Present Disclosure

### Knowledge Acquired by Inventors

Knowledge acquired by inventors will now be described.

In recent years, in order to mount a plurality of optical fibers at high density for use as an optical cable, there has been a need to decrease the outer circumferential diameter of each optical fiber. Specifically, the outer circumferential diameter of a recently used optical fiber is 200 μm or less.

In processing of manufacturing an optical fiber that has such a small diameter, the optical fiber is more likely to be broken than an optical fiber having a past outer circumferential diameter. The break of the optical fiber during manufacturing raises a possibility of a decrease in manufacturing efficiency of the optical fiber. For this reason, there is a need for an improvement used in manufacturing.

The disclosers have seriously considered the problem described above and consequently found that the frequency of break of an optical fiber during manufacturing depends on the amount of eccentricity of a glass fiber in the optical fiber.

If the glass fiber vibrates in the radial direction of the glass fiber when passing through a dice in a resin-coating device, the glass fiber is eccentric with respect to an opening of the dice, and a resin coating layer is formed in this state. For this reason, the thickness of the resin coating layer decreases in a direction in which the central axis of the glass fiber is eccentric from the central axis of the optical fiber. In this case, there is a possibility that a high stress is locally applied to the glass fiber via a thin portion of the resin coating layer when the optical fiber comes into contact with a burr of a guide roller or a foreign substance on the guide roller. For this reason, the glass fiber may suffer damage such as a crack. Consequently, there is a possibility that the optical fiber is broken due to the damage of the glass fiber.

In view of this, the disclosers have considered the amount of eccentricity of the glass fiber described above by applying the Fourier transform of a waveform that represents the amount of eccentricity of the glass fiber at a position along the axial direction of the glass fiber and analyzing a spectrum acquired by the Fourier transform. Consequently, the disclosers have found which factor in the spectrum affects the break of the optical fiber.

Consequently, the disclosers have succeeded in suppressing the optical fiber from being broken by adjusting the factor that affects the break of the optical fiber in the spectrum acquired by the Fourier transform of an eccentricity waveform of the glass fiber.

The present disclosure is based on the above knowledge that the present disclosers have found.

### Embodiment of Present Disclosure

An embodiment of the present disclosure will now be listed and described.

(1) An optical fiber according to an aspect of the present disclosure includes a glass fiber, and a resin coating layer covering an outer circumference of the glass fiber. In a spectrum acquired by measuring an amount of eccentricity of the glass fiber from a central axis based on an outer circumference of the resin coating layer at a plurality of measurement points set at a predetermined interval in an axial direction of the glass fiber and applying Fourier transform of a waveform representing the amount of eccentricity at each of the plurality of measurement points, a largest value of amplitude of the amount of eccentricity is 6 μm or less.

This structure inhibits the optical fiber from being broken.

(2) In the optical fiber described above in (1), a wavelength at which amplitude of the amount of eccentricity is largest is 0.1 m or more.

This structure stably inhibits the optical fiber from being broken.

(3) An optical fiber according to another aspect of the present disclosure includes a glass fiber, and a resin coating layer covering an outer circumference of the glass fiber. In a spectrum acquired by measuring an amount of eccentricity of the glass fiber from a central axis based on an outer circumference of the resin coating layer at a plurality of measurement points set at a predetermined interval in an axial direction of the glass fiber and applying Fourier transform of a waveform representing the amount of eccentricity at each of the plurality of measurement points, a wavelength at which amplitude of the amount of eccentricity is largest is 0.1 m or more.

This structure inhibits the optical fiber from being broken.

(4) A method of manufacturing an optical fiber according to another aspect of the present disclosure includes forming a glass fiber, forming a resin coating layer such that an outer circumference of the glass fiber is covered, curing the resin coating layer by using a predetermined curing device, and pulling the optical fiber the resin coating layer of which is cured. Forming the resin coating layer includes setting an outer circumferential diameter of the resin coating layer to 190 μm or less. Pulling the optical fiber includes setting a circumference length of a largest roller among all rollers to 0.2 m or more, the largest roller consists of a turning roller located just beneath the curing device and a plurality of guide rollers located downstream from the turning roller.

This feature inhibits the optical fiber from being broken.

(5) In the method described above in (4), pulling the optical fiber includes damping vibration of the optical fiber by using a vibration damper installed downstream of the curing device and upstream of the turning roller.

This feature stably inhibits the optical fiber from being broken.

(6) In the method described above in (4), pulling the optical fiber includes using the turning roller which is fixed separately from another device member related to manufacturing of the optical fiber.

This feature stably inhibits the optical fiber from being broken.

(7) In the method described above in (4), pulling the optical fiber includes damping vibration of the optical fiber by using a vibration damper installed downstream of the curing device and upstream of the turning roller and using the turning roller which is fixed separately from another device member related to manufacturing of the optical fiber.

This feature stably inhibits the optical fiber from being broken.

(8) A method of manufacturing an optical fiber according to another aspect of the present disclosure includes forming a glass fiber, forming a resin coating layer such that an outer circumference of the glass fiber is covered, curing the resin coating layer by using a predetermined curing device, and pulling the optical fiber the resin coating layer of which is cured. Forming the resin coating layer includes setting an outer circumferential diameter of the resin coating layer to 190 μm or less. Pulling the optical fiber includes damping vibration of the optical fiber by using a vibration damper installed downstream of the curing device and upstream of a turning roller located directly beneath the curing device.

This feature inhibits the optical fiber from being broken.

(9) In the method described above in (8), pulling the optical fiber includes using the turning roller which is fixed separately from another device member related to manufacturing of the optical fiber.

This feature stably inhibits the optical fiber from being broken.

(10) A method of manufacturing an optical fiber according to another aspect of the present disclosure includes forming a glass fiber, forming a resin coating layer such that an outer circumference of the glass fiber is covered, curing the resin coating layer by using a predetermined curing device, and pulling the optical fiber the resin coating layer of which is cured. Forming the resin coating layer includes setting an outer circumferential diameter of the resin coating layer to 190 μm or less. Pulling the optical fiber includes using a turning roller which is located just beneath the curing device and fixed separately from another device member related to manufacturing of the optical fiber.

This structure inhibits the optical fiber from being broken.

### Detail of Embodiment of Present Disclosure

An embodiment of the present disclosure will now be described with reference the drawings. The present disclosure is not limited to these examples, is shown by claims, and includes all modifications having the equivalent meaning and scope as those of the claims.

### Embodiment of Present Disclosure

### (1) Optical Fiber

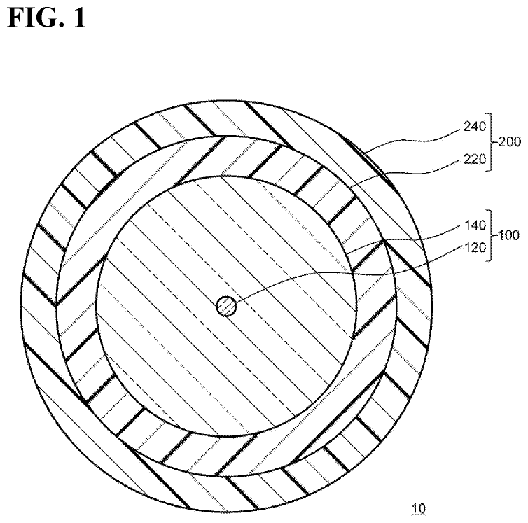

An optical fiber 10 according to an embodiment of the present disclosure will be described with reference to FIG. 1. FIG. 1 schematically illustrates a sectional view of the optical fiber according to the present embodiment.

In the following description, the “axial direction” of a glass fiber 100 means the direction of the central axis of the glass fiber 100 and can be also referred to as the longitudinal direction of the glass fiber 100. The “radial direction” of the glass fiber 100 means the direction perpendicular to the axial direction of the glass fiber 100 and can be also referred to as the transverse direction of the glass fiber 100 in some cases. The “circumferential direction” of the glass fiber 100 means the direction (a circumferential direction in FIG. 1) of the outer circumference of the glass fiber 100. The same words as those for the glass fiber 100 can be used for the optical fiber 10.

As illustrated in FIG. 1, the optical fiber 10 according to the present embodiment is formed as, for example, a fibrous body acquired by covering the outer circumference of the glass fiber 100 with a resin coating layer 200. That is, the optical fiber 10 includes, for example, the glass fiber 100 and the resin coating layer 200 in this order in the direction from the central axis of the glass fiber 100 to the outer circumference.

The meaning of the words “optical fiber 10” includes an uncolored optical fiber and a colored optical fiber. The optical fiber 10 will be described below as, for example, the uncolored optical fiber.

### Glass Fiber

For example, the glass fiber 100 serves as an optical transmitter through which light that enters the optical fiber 10 travels in the axial direction of the optical fiber 10. For example, the glass fiber 100 is also referred to as an “uncoated optical fiber”. The base material (the main component) of the glass fiber 100 is silica (SiO₂) glass and includes a core 120 and a cladding 140.

### Resin Coating Layer

For example, the resin coating layer 200 covers the outer circumference of the glass fiber 100 and protects the glass fiber 100.

According to the present embodiment, the resin coating layer 200 includes, for example, a first resin coating layer (a primary resin coating layer) 220, and a second resin coating layer (a secondary resin coating layer) 240.

For example, the first resin coating layer 220 covers the outer circumference of the cladding 140 of the glass fiber 100 and is in contact with the outer circumference of the cladding 140. For example, the second resin coating layer 240 covers the outer circumference of the first resin coating layer 220 and is in contact with the outer circumference of the first resin coating layer 220.

The first resin coating layer 220 and the second resin coating layer 240 are composed of, for example, a cured material acquired by curing an ultraviolet-curable resin composition with ultraviolet radiation. An example of base resin in the ultraviolet-curable resin composition is urethane acrylate.

According to the present embodiment, the optical fiber 10 has, for example, a diameter smaller than that in the past. Specifically, the outer diameter (that is, the outer diameter of the second resin coating layer 240) of the resin coating layer 200 described above is, for example, 190 μm or less. This enables a plurality of optical fibers 10 to be packed at high density in an optical cable.

### (2) Amount of Eccentricity of Glass Fiber

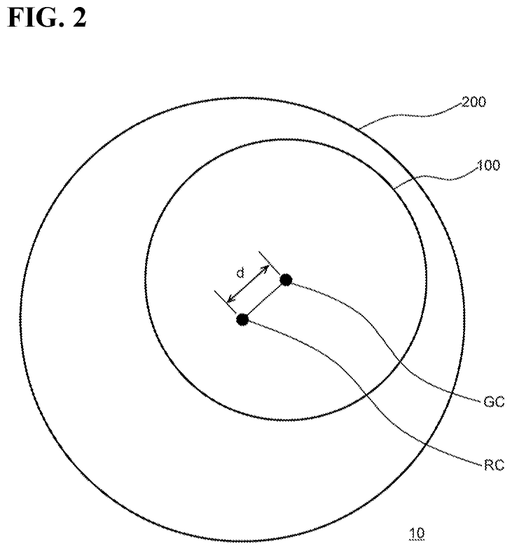

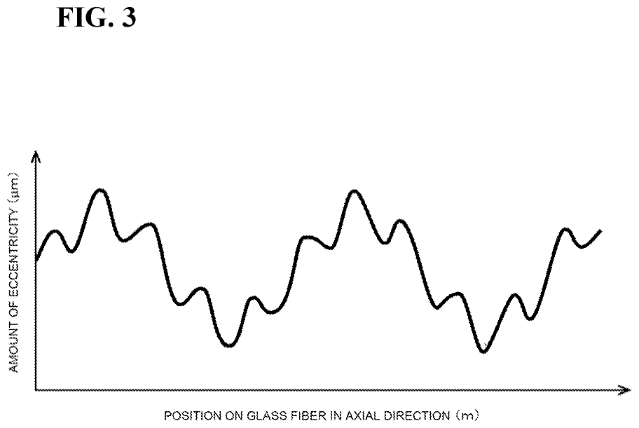

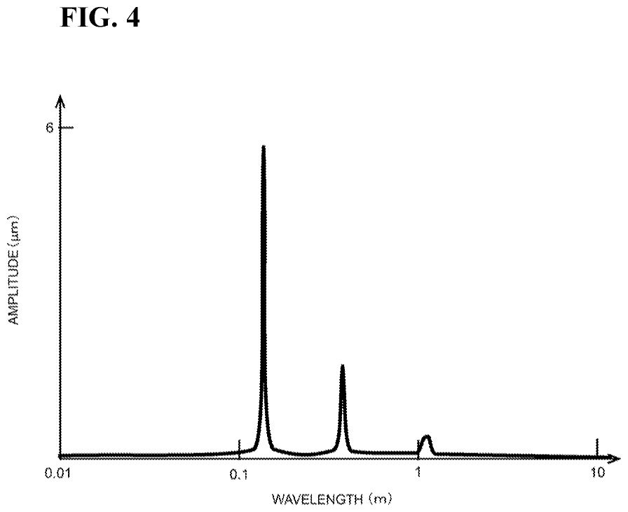

The amount of eccentricity of the glass fiber 100 according to the present embodiment will now be described with reference to FIG. 2 to FIG. 4. FIG. 2 schematically illustrates a sectional view for describing the definition of the amount of eccentricity of the glass fiber. FIG. 3 illustrates an eccentricity waveform that represents the amount of eccentricity of the glass fiber at a position on the glass fiber in the axial direction. FIG. 4 illustrates an example of a spectrum acquired by the Fourier transform of the eccentricity waveform.

The definition of the amount of eccentricity of the glass fiber will now be described with reference to FIG. 2. FIG. 2 is a diagram for description and does not illustrate a state of the optical fiber 10 according to the present embodiment. The same reference characters as those in FIG. 1 are used for convenience of description.

As illustrated in FIG. 2, the amount d of eccentricity of the glass fiber 100 is defined as a distance (the amount of deviation in the radial direction, or the amount of displacement in the radial direction) from a central axis RC based on an outer circumference of the resin coating layer 200 to a central axis GC of the glass fiber 100.

The amount of eccentricity of the glass fiber 100 is measured by, for example, a device for observing a variation in the amount of eccentricity.

The device for observing the variation in the amount of eccentricity serves as an image recognition device for eccentricity and includes, for example, a first light source, a first imaging unit, a second light source, and a second imaging unit.

The first light source is disposed so as to radiate light in the transverse direction of the optical fiber 10 to be measured. The wavelength of the light of the first light source includes a wavelength transmitted through the resin coating layer 200. The first imaging unit faces the first light source with the optical fiber 10 to be measured interposed therebetween and acquires the image of the light that travels through the optical fiber 10. The second light source and the second imaging unit have the same structures as those of the first light source and the first imaging unit except that the second light source and the second imaging unit are arranged so as to be perpendicular to a direction in which the first light source and the first imaging unit face each other.

With this structure, the position of the outer circumference of the resin coating layer 200 and the position of the inner circumference of the resin coating layer 200 (the position of the outer circumference of the glass fiber 100) are acquired based on the light that travels through the optical fiber 10 in the directions of two axes that are perpendicular to the central axis of the optical fiber 10 and that are perpendicular to each other, and the amount of eccentricity of the glass fiber 100 can be measured as the distance between the centers thereof. That is, the amount of eccentricity of the glass fiber 100 can be measured with non-destructive inspection for the optical fiber 10.

The amount of eccentricity of the glass fiber 100 is measured at a plurality of measurement points that are set at a predetermined interval in the axial direction of the glass fiber 100, and the result of measurement is plotted in a graph in which the horizontal axis represents the positions of the plurality of measurement points, and the vertical axis represents the amount of eccentricity at each position. This enables a waveform (distribution) of the amount of eccentricity to be acquired. In the following description, the waveform of the amount of eccentricity of the glass fiber 100 is also referred to as the “eccentricity waveform”.

As a result of the measurement described above, an eccentricity waveform illustrated in FIG. 3, for example, is acquired. The value of the “amount of eccentricity” on the vertical axis in FIG. 3 is the absolute value of the amount of eccentricity irrelevant to a direction. In other words, the “amount of eccentricity” corresponds to a radius r in a polar coordinates system.

In practice, as illustrated in FIG. 3, the eccentricity waveform of the optical fiber 10 is not a clean sine wave but has a complicated shape due to, for example, an amount of vibration at parts of an optical-fiber-manufacturing apparatus 50 described later, the direction of vibration, and a vibration frequency.

In view of this, as illustrated in FIG. 4, the inventors have applied the Fourier transformation on the eccentricity waveform of the optical fiber 10 and analyzed a spectrum acquired by the Fourier transform.

Consequently, the inventors have found that the “largest value of amplitude of the amount of eccentricity” or the “wavelength at which the amplitude of the amount of eccentricity is largest” in the spectrum acquired by the Fourier transformation of the eccentricity waveform affects break of the optical fiber 10. A component in which the amplitude of the amount of eccentricity is largest is also referred to as a “largest-amplitude component”.

Based on the knowledge described above, the optical fiber 10 according to the present embodiment preferably satisfies at least one of requirements described below regarding the amount of eccentricity of the glass fiber 100.

According to the present embodiment, as illustrated in FIG. 4, the largest value (the value of amplitude of the largest-amplitude component) of the amplitude of the amount of eccentricity in the spectrum acquired by the Fourier transformation of the eccentricity waveform of the glass fiber 100 is, for example, 6 μm or less.

When the largest value of the amplitude of the amount of eccentricity is more than 6 μm, the eccentricity of the glass fiber 100 is locally high at a position at which components of the amount of eccentricity at different wavelengths overlap. For this reason, the resin coating layer is likely to be locally thin. Consequently, there is a possibility that the frequency of break of the optical fiber 10 increases. In contrast, according to the present embodiment, the largest value of the amplitude of the amount of eccentricity is 6 μm or less, and accordingly, the eccentricity of the glass fiber 100 can be inhibited from being locally high even when the components of the amount of eccentricity at different wavelengths overlap. This inhibits the resin coating layer from being locally thin. Consequently, the frequency of break of the optical fiber 10 can be decreased.

The largest value of the amplitude of the amount of eccentricity is not particularly limited but is preferably close to 0 μm as much as possible.

According to the present embodiment, as illustrated in FIG. 4, the wavelength (the wavelength of the largest-amplitude component) at which the amplitude of the amount of eccentricity is largest in the spectrum acquired by the Fourier transformation of the eccentricity waveform of the glass fiber 100 is, for example, 0.1 m or more.

When the wavelength at which the amplitude of the amount of eccentricity is largest is less than 0.1 m, the component in which the amplitude of the amount of eccentricity is largest overlaps other components having different wavelengths at many points on the optical fiber 10. For this reason, at many points on the optical fiber 10, the resin coating layer is locally thin. That is, the number of thin portions of the resin coating layer increases per unit length in the axial direction of the glass fiber 100. Consequently, there is a possibility that the frequency of break of the optical fiber 10 increases. In contrast, according to the present embodiment, the wavelength at which the amplitude of the amount of eccentricity is largest is 0.1 m or more, and accordingly, “other components having different wavelengths” that overlap the component in which the amplitude of the amount of eccentricity is largest can be decreased. This inhibits the resin coating layer from being locally thin. That is, the number of thin portions of the resin coating layer can be inhibited from increasing per unit length in the axial direction of the glass fiber 100. Consequently, the frequency of break of the optical fiber 10 can be decreased.

The upper limit of the wavelength at which the amplitude of the amount of eccentricity is largest is not particularly limited but is preferably increased as much as possible. In consideration of, for example, running velocity of the optical fiber 10 in the optical-fiber-manufacturing apparatus 50 described below, the wavelength at which the amplitude of the amount of eccentricity is largest is, for example, 1 m or less.

### (3) Optical-Fiber-Manufacturing Apparatus

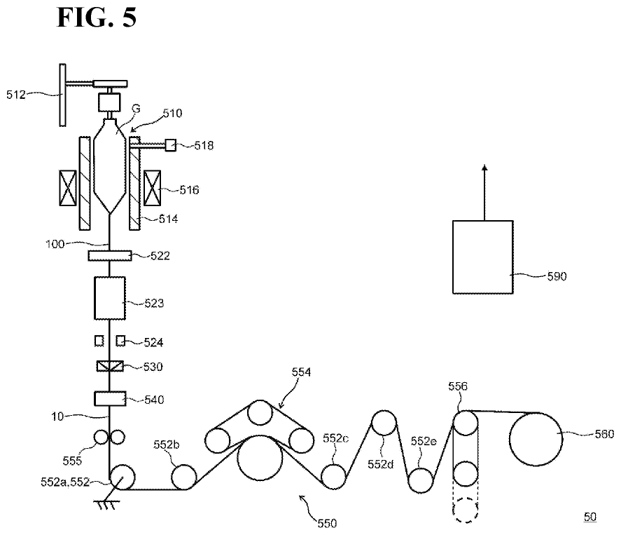

The optical-fiber-manufacturing apparatus 50 according to the present embodiment will now be described with reference to FIG. 5. FIG. 5 schematically illustrates the structure of the optical-fiber-manufacturing apparatus according to the present embodiment.

As illustrated in FIG. 5, the optical-fiber-manufacturing apparatus 50 according to the present embodiment includes, for example, a drawing furnace 510, a fiber-position-measuring unit 522, a cooling device 523, an outer-diameter-measuring unit 524, a resin-coating device 530, a curing device 540, a tractive unit 550, a bobbin 560, and a control unit 590. Device members other than the control unit 590 are arranged in this order.

Portions of the device members of the optical-fiber-manufacturing apparatus 50 near a holding mechanism 512 will be described by using the word “upstream”, and portions thereof near the bobbin 560 will be described by using the word “downstream”.

The drawing furnace 510 forms the glass fiber 100. A glass material G is heated by the drawing furnace 510, softened glass is stretched, and consequently, the glass fiber 100 that has a small diameter is formed.

The fiber-position-measuring unit 522 measures the position of the glass fiber 100 in the horizontal direction.

The cooling device 523 cools the glass fiber 100 that is formed by the drawing furnace 510.

The outer-diameter-measuring unit 524 measures the outer circumferential diameter of the glass fiber 100 before resin coating.

The resin-coating device 530 forms the resin coating layer 200 such that the outer circumference of the glass fiber 100 is covered. The resin-coating device 530 includes dices for applying an ultraviolet-curable resin composition to the outer circumference of the glass fiber 100 with the glass fiber 100 inserted therein.

According to the present embodiment, the resin-coating device 530 includes two dices for forming the first resin coating layer 220 and the second resin coating layer 240 in this order in the direction from the central axis of the glass fiber 100 to the outer circumference.

The curing device 540 radiates an ultraviolet ray to the resin coating layer 200 and cures the resin coating layer 200.

For example, the tractive unit 550 is configured to pull the optical fiber 10 after the resin coating layer 200 being cured. Specifically, the tractive unit 550 includes, for example, a plurality of guide rollers 552 and 556 and a capstan 554. For example, a turning roller 552a that is one of the plurality of guide rollers 552 is located just beneath the curing device 540. For example, the capstan 554 is disposed downstream of the turning roller 552a and pulls the optical fiber 10 by applying predetermined tensile force while holding the optical fiber 10 between a belt and a roller. Screening rollers 552c, 552d, and 552e of the plurality of guide rollers 552 are disposed downstream of the capstan 554 and apply screening tensile force to the optical fiber 10 together with the capstan 554. The guide roller 556 is disposed downstream of the screening roller 552e and adjusts the tensile force of the optical fiber 10 by moving upward or downward depending on a variation in the tensile force of the optical fiber 10.

For example, the bobbin 560 is disposed downstream of the guide roller 556 and winds the optical fiber 10.

For example, the control unit 590 is connected to the components of the optical-fiber-manufacturing apparatus 50 and controls the components. An example of the control unit 590 is a computer.

According to the present embodiment, for example, the optical-fiber-manufacturing apparatus 50 has the following structure to manufacture the optical fiber 10 that satisfies requirements for the amount of eccentricity of the glass fiber 100 described above.

According to the present embodiment, the circumference length of the largest roller among all rollers including the turning roller 552a and the plurality of guide rollers 552 located downstream of the turning roller 552a is, for example, 0.2 m or more.

For example, the circumference length of the largest guide roller 552 is preferably 0.9 m or less.

According to the present embodiment, as illustrated in FIG. 5, the tractive unit 550 includes, for example, a vibration damper 555. For example, the vibration damper 555 is installed downstream of the curing device 540 and upstream of the turning roller 552a located just beneath the curing device 540. As for the vibration damper 555, for example, two rollers are in contact with the optical fiber in different directions, and the vibration of the optical fiber 10 is dampened.

The vibration damper 555 enables the position of the central axis of the glass fiber 100 to be stably maintained by dampening the vibration of the optical fiber 10. That is, the glass fiber 100 can be inhibited from being eccentric.

According to the present embodiment, as illustrated in FIG. 5, the turning roller 552a located just beneath the curing device 540 is fixed separately from, for example, the other device members related to manufacturing of the optical fiber 10. Specifically, for example, the turning roller 552a is not connected to the other device members but is fixed to a floor.

The turning roller 552a is used in a state in which the turning roller 552a fixed separately from the other device members related to manufacturing of the optical fiber 10. This inhibits vibrations from the other device members from being transmitted to the turning roller 552a. Consequently, in the spectrum acquired by the Fourier transformation of the eccentricity waveform of the glass fiber 100, the largest value of the amplitude of the amount of eccentricity can be decreased, and the wavelength at which the amplitude of the amount of eccentricity is largest can be increased.

### Another Embodiment of Present Disclosure

The embodiment of the present disclosure is specifically described above. The present disclosure, however, is not limited to the embodiment described above and can be modified in various ways without departing from the sprit thereof.

In the figures and description according to the above embodiment, the optical fiber 10 is an uncolored optical fiber. The optical fiber 10, however, may be a colored optical fiber as described above. That is, the optical fiber 10 may include a colored layer that covers the outer circumference of the resin coating layer 200.

In the description according to the above embodiment, the resin coating layer 200 includes two layers but is not limited thereto. The resin coating layer 200 may include only a single layer or may include three or more layers.

In the description according to the above embodiment, the optical fiber 10 satisfies requirements (i) and (ii) described below regarding the amount of eccentricity of the glass fiber 100 but is not limited thereto.

(i) The largest value of the amplitude of the amount of eccentricity in the spectrum acquired by the Fourier transformation of the eccentricity waveform of the glass fiber 100 is 6 μm or less.

(ii) The wavelength at which the amplitude of the amount of eccentricity is largest in the spectrum acquired by the Fourier transformation of the eccentricity waveform of the glass fiber 100 is 0.1 m or more.

When the optical fiber 10 satisfies at least the requirement (i) or (ii), at least the frequency of break of the optical fiber 10 can be decreased. When the requirements (i) and (ii) described above are satisfied, the above effect can be stably achieved.

In the description according to the above embodiment, all of (x), (y), and (z) are carried out to manufacture the optical fiber 10 that satisfies the requirements described above regarding the amount of eccentricity of the glass fiber 100 but is not limited thereto.

(x) The circumference length of the largest roller is set to 0.2 m or more. The largest roller is has the largest circumference length among all rollers including the turning roller 552a located just beneath the curing device 540 and the plurality of guide rollers 552 located downstream of the turning roller 552a is set to 0.2 m or more.

(y) The vibration of the optical fiber 10 is dampened by the vibration damper 555 installed downstream of the curing device 540 and upstream of the turning roller 552a located just beneath the curing device 540.

(z) The turning roller 552a located just beneath the curing device 540 is used with the turning roller 552a fixed separately from the other device members related to manufacturing of the optical fiber 10.

At least the effect described above can be achieved by carrying out at least one of (x), (y), and (z). When two or more of (x), (y), and (z) described above are carried out, the above effect can be stably achieved.

### Example

An example of the present disclosure will now be described. The example corresponds to an example of the present disclosure, and the present disclosure is not limited to the example.

### (1) Manufacturing of Optical Fiber

Optical fibers of samples A1 to A4, B1, and B2 were manufactured in conditions in Table 1 described later.

Common conditions that are not described in Table 1 are as follows.

The outer circumferential diameter of each glass fiber was 125 μm.

The number of layers in each resin coating layer was 2.

### (2) Evaluation

### Measurement of Amount of Eccentricity

The amount of eccentricity of each glass fiber was measured at a plurality of measurement points that were set at a predetermined interval in the axial direction of the glass fiber by using the device for observing the variation in the amount of eccentricity, and consequently, the waveform of the amount of eccentricity at each of the plurality of measurement points was acquired.

Subsequently, the fast Fourier transformation (FFT) of the eccentricity waveform of each optical fiber was applied, and the spectrum acquired by the Fourier transformation was analyzed. The “largest value of the amplitude of the amount of eccentricity” and the “wavelength at which the amplitude of the amount of eccentricity was largest” in the spectrum acquired by the Fourier transformation of the eccentricity waveform were thus acquired. In the following description, the “wavelength at which the amplitude of the amount of eccentricity was largest” is described as the “wavelength of the largest-amplitude component”.

### Measurement of Frequency of Break

The optical fibers of the samples described above were rewound with a tensile force of 1.5 kg applied thereto, and the number of times the optical fibers were broken was measured. As for the samples, the frequency of break was acquired as the number of times of break per 1000 kilometers (Mm). The result was evaluated as “good” in the case where the frequency of break was less than 5 times/Mm and as “failure” in the case where the frequency of break was 5 times/Mm or more.

### (3) Result

The result of evaluation of the samples will now be described by using Table 1 described below.

TABLE 1

| | Manufacturing Condition | | | | Result of Evaluation | | |
|---|---|---|---|---|---|---|---|
| | | | | Separate | Largest Value of | Wavelength of | |
| | Outer Circumferential | Circumference | | Fixation of | Amplitude of | Largest- | Frequency of |
| | Diameter of Resin | Length of Largest | Vibration | Turning | Amount of | amplitude | Break |
| | Coating Layer | Guide Roller | Damper | Roller | Eccentricity | component | (times/Mm) |
| Sample A1 | 180 μm | 0.3 m | Present | Present | 0.9 μm | 0.42 m | 0.1 |
| Sample A2 | 180 μm | 0.2 m | Present | Present | 3.6 μm | 0.12 m | 1.8 |
| Sample A3 | 180 μm | 0.2 m | Absent | Present | 5.2 μm | 0.13 m | 2 |
| Sample A4 | 180 μm | 0.2 m | Absent | Absent | 6 μm | 0.1 m | 4.1 |
| Sample B1 | 190 μm | 0.15 m | Absent | Absent | 7 μm | 0.06 m | 14 |
| Sample B2 | 250 μm | 0.15 m | Absent | Absent | 6.9 μm | 0.06 m | 5 |

### Samples B1 and B2

As for the samples B1 and B2, the largest value of the amplitude of the amount of eccentricity in the spectrum acquired by the Fourier transformation of the eccentricity waveform was more than 6 μm. The wavelength at which the amplitude of the amount of eccentricity was largest in the spectrum acquired by the Fourier transformation of the eccentricity waveform was less than 0.1 m.

Consequently, as for the samples B1 and B2, the optical fibers were likely to be broken, and the frequency of break was 5 times/Mm or more. The frequency of break of the sample B1 having a relatively small diameter tended to be more than that of the sample B2 having a past outer circumferential diameter.

As for the samples B1 and B2, the circumference length of the largest guide roller was less than 0.2 m, and the optical fibers were not stably pulled by the largest guide roller. As for the samples B1 and B2, no vibration dampers were provided, and the positions of the central axes of the glass fibers were highly eccentric or were eccentric in a short cycle due to a vibration from the tractive unit when the resin coating layers were coated. As for the samples B1 and B2, the turning roller was used with the turning roller connected to the other device members, and the vibration of the turning roller increased, or the cycle thereof decreased.

As for the samples B1 and B2, for these reasons, the largest value of the amplitude of the amount of eccentricity in the spectrum acquired by the Fourier transformation of the eccentricity waveform increased, or the wavelength at which the amplitude of the amount of eccentricity was largest decreased. It is thought that the frequency of break for the samples B1 and B2 consequently increased. It is also thought that as the diameter of the optical fiber decreased, the optical fiber was more likely to be broken.

### Samples A1 to A4

As for the samples A1 to A4, the largest value of the amplitude of the amount of eccentricity in the spectrum acquired by the Fourier transformation of the eccentricity waveform was 6 μm or less. The wavelength at which the amplitude of the amount of eccentricity was largest in the spectrum acquired by the Fourier transformation of the eccentricity waveform was 0.1 m or more.

Consequently, as for the samples A1 to A4, the optical fibers were unlikely to be broken, and the frequency of break was less than 5 times/Mm.

As for the samples A1 to A4, the circumference length of the largest guide roller was 0.2 m or more, and the optical fibers were stably pulled by the largest guide roller.

As for the samples A1 and A2, the vibration dampers were provided, the positions of the central axes of the glass fibers were stably maintained when the resin coating layers were coated.

As for the samples A1 to A3, the turning roller was used with the turning roller fixed separately from the other device members. Consequently, the vibration of the turning roller was inhibited from increasing, and the cycle was inhibited from decreasing.

As for the samples A1 to A4, in this way, the largest value of the amplitude of the amount of eccentricity in the spectrum acquired by the Fourier transformation of the eccentricity waveform was decreased, and the wavelength at which the amplitude of the amount of eccentricity was largest was increased. It was confirmed that as for the samples A1 to A4, the frequency of break was consequently decreased even though the diameters thereof were smaller than that of the sample B 1.

What is claimed is:

1. An optical fiber comprising:
a glass fiber; and
a resin coating layer covering an outer circumference of the glass fiber,
wherein in a spectrum acquired by measuring an amount of eccentricity of the glass fiber from a central axis based on an outer circumference of the resin coating layer at a plurality of measurement points set at a predetermined interval in an axial direction of the glass fiber and applying Fourier transform of a waveform representing the amount of eccentricity at each of the plurality of measurement points, a largest value of amplitude of the amount of eccentricity is 6 μm or less.

2. The optical fiber according to claim 1,
wherein a wavelength at which amplitude of the amount of eccentricity is largest is 0.1 m or more.

3. An optical fiber comprising:
a glass fiber; and
a resin coating layer covering an outer circumference of the glass fiber,
wherein in a spectrum acquired by measuring an amount of eccentricity of the glass fiber from a central axis based on an outer circumference of the resin coating layer at a plurality of measurement points set at a predetermined interval in an axial direction of the glass fiber and applying Fourier transform of a waveform representing the amount of eccentricity at each of the plurality of measurement points, a wavelength at which amplitude of the amount of eccentricity is largest is 0.1 m or more.

4. A method of manufacturing an optical fiber, the method comprising:
forming a glass fiber;
forming a resin coating layer such that an outer circumference of the glass fiber is covered;
curing the resin coating layer by using a predetermined curing device; and
pulling the optical fiber the resin coating layer of which is cured,
wherein forming the resin coating layer includes setting an outer circumferential diameter of the resin coating layer to 190 μm or less, and
wherein pulling the optical fiber includes setting a circumference length of a largest roller among all rollers to 0.2 m or more, the largest roller consists of a turning roller located just beneath the curing device and a plurality of guide rollers located downstream from the turning roller.

5. The method according to claim 4,
wherein pulling the optical fiber includes damping vibration of the optical fiber by using a vibration damper installed downstream of the curing device and upstream of the turning roller.

6. The method according to claim 4,
wherein pulling the optical fiber includes using the turning roller which is fixed separately from another device member related to manufacturing of the optical fiber.

7. The method according to claim 4,
wherein pulling the optical fiber includes damping vibration of the optical fiber by using a vibration damper installed downstream of the curing device and upstream of the turning roller and using the turning roller which is fixed separately from another device member related to manufacturing of the optical fiber.

8. A method of manufacturing an optical fiber, the method comprising:
forming a glass fiber;
forming a resin coating layer such that an outer circumference of the glass fiber is covered;
curing the resin coating layer by using a predetermined curing device; and
pulling the optical fiber the resin coating layer of which is cured,
wherein forming the resin coating layer includes setting an outer circumferential diameter of the resin coating layer to 190 μm or less, and
wherein pulling the optical fiber includes damping vibration of the optical fiber by using a vibration damper installed downstream of the curing device and upstream of a turning roller located just beneath the curing device.

9. The method according to claim 8,
wherein pulling the optical fiber includes using the turning roller which is fixed separately from another device member related to manufacturing of the optical fiber.

10. A method of manufacturing an optical fiber, the method comprising:
forming a glass fiber;
forming a resin coating layer such that an outer circumference of the glass fiber is covered;
curing the resin coating layer by using a predetermined curing device; and
pulling the optical fiber the resin coating layer of which is cured,
wherein forming the resin coating layer includes setting an outer circumferential diameter of the resin coating layer to 190 μm or less, and
wherein pulling the optical fiber includes using a turning roller which is located just beneath the curing device and fixed separately from another member related to manufacturing of the optical fiber.
